(19) United States
(12) Patent Application Publication
(10) Pub. No.: US 2004/0203537 A1
(43) Pub. Date: Oct. 14, 2004

(54) Wireless transmission module

(76) Inventors: Shikio Yoshida, Nara-Shi (JP); Akiteru Deguchi, Yamatokoriyama-Shi (JP)

Correspondence Address: BIRCH STEWART KOLASCH & BIRCH, PO BOX 747, FALLS CHURCH, VA, 22040-0747, US

(21) Appl. No.: 10/823,574

(22) Filed: Apr. 14, 2004

(30) Foreign Application Priority Data
Apr. 14, 2003 (JP) 2003-109292

(51) Int. Cl. H04M 1/00; H04B 1/38

(52) U.S. Cl. 455/90.3; 455/558

(57) ABSTRACT

A wireless transmission/reception card has a pole-shaped antenna for wireless transmission and reception, and the length direction of the antenna is substantially parallel to the main faces of the card. A headset has a slot in which the wireless transmission/reception card is inserted, and, when the card is inserted in the slot, the pole-shaped antenna of the card is set upright substantially in the vertical direction in the normal use state of the headset. The wireless transmission/reception card excels in portability, and, when inserted in the slot of the headset, helps enhance the antenna gain in the horizontal plane in the normal use state.

This nonprovisional application claims priority under 35 U.S.C. § 119(a) on Patent Application No. 2003-109292 filed in Japan on Apr. 14, 2003, the entire contents of which are hereby incorporated by reference.

### BACKGROUND OF THE INVENTION

1. Field of the Invention

The present invention relates to a wireless transmission module, such as a wireless transmission/reception card, that is used as a part of a wireless network system that permits wireless transmission of AV streams, IP data, and the like.

2. Description of the Prior Art

In recent years, wireless network systems have been becoming increasingly popular. One example of a wireless mobile terminal that functions as a part of such a wireless network system is a notebook personal computer 101 having a wireless LAN card 100 operating in the 2.4 GHz band attached thereto as shown in FIG. 7. The wireless LAN card 100 incorporates interior antennas 102 in the shape of patches, and is attached to the notebook personal computer 101 in such a way that the main faces of the card are kept horizontal in the normal use state. It should be noted here that the main faces denote, of the six faces of a substantially rectangular parallelepiped shape, the two which have the largest area.

Japanese Patent Application Laid-Open No. 2001-28560 discloses a mobile communication terminal provided with pole-shaped antennas that protrude outward. In this mobile communication terminal, the pole-shaped antennas are fitted directly to one of the main faces of the mobile communication terminal in such a way that the length direction of the pole-shaped antennas coincides with the direction normal to the main faces. This helps obtain an enhanced antenna gain in the horizontal direction in the normal use state. Moreover, in the mobile communication terminal disclosed in Japanese Patent Application Laid-Open No. 2001-28560, interior antennas in the shape of patches are arranged respectively inside the two main faces of the mobile communication terminal. This helps obtain an enhanced antenna gain in the vertical direction in the normal use state.

However, with the wireless LAN card 100 shown in FIG. 7, since the antennas are arranged in the interior of the card, it is difficult to obtain satisfactory antenna gains in all directions through 360 degrees in the horizontal plane. This problem can be overcome by running an antenna cable 103 out of the wireless LAN card 100 and connecting it to an externally placed high-gain antenna 104. This, however, makes it necessary to carry around the high-gain antenna 104 when the user carries around the notebook personal computer 101 as a wireless mobile terminal, and to place the high-gain antenna 104 somewhere or hold it in some way when the user uses it. This is troublesome.

In the mobile communication terminal (for example, implemented as a wireless LAN card) disclosed in Japanese Patent Application Laid-Open No. 2001-28560, the pole-shaped antennas protrude perpendicularly from one of the main faces of the mobile communication terminal. This gives the mobile communication terminal a shape that is difficult to carry around. One way to make it easier to carry around is to provide hinges 105 to make the pole-shaped antennas 106 foldable as in the wireless LAN card shown in FIGS. 9A and 9B. Making the pole-shaped antennas 106 foldable in this way, however, makes it necessary to set the pole-shaped antennas 106 upright so that their length direction coincides with the direction normal to the main faces of the wireless LAN card, i.e., to bring the pole-shaped antennas 106 from the state shown in FIG. 9A to the state shown in FIG. 9B, every time the wireless LAN card is used. This operation is troublesome.

Moreover, in both the wireless LAN card 100 shown in FIG. 7 and the mobile communication terminal disclosed in Japanese Patent Application Laid-Open No. 2001-28560, the pole-shaped antennas are, in the normal use state, located at a level lower than the level of the face of the user. Thus, depending on the position of the transmission/reception partner (for example, a wireless access point, wireless home gateway, or the like), the pole-shaped antennas as seen from the transmission/reception partner may be located behind the body of the user. This lowers the gain of the pole-shaped antennas.

### SUMMARY OF THE INVENTION

An object of the present invention is to provide a wireless transmission/reception card that excels in portability and that, when attached to a particular appliance, offers an enhanced antenna gain in the horizontal plane in the normal use state. Another object of the present invention is to provide such a particular appliance. Still another object of the present invention is to provide a wireless network terminal built with such a wireless transmission/reception card and such a particular appliance.

To achieve the first object, according to one aspect of the present invention, a wireless transmission/reception card is provided with a pole-shaped antenna for wireless transmission and reception. Here, the length direction of the pole-shaped antenna is substantially parallel to the main faces of the wireless transmission/reception card.

To achieve the second object, according to another aspect of the present invention, a wireless transmission/reception card supporting apparatus is provided with a mount on which the wireless transmission/reception card described above is mounted. Here, when the wireless transmission/reception card is mounted on the mount, the pole-shaped antenna thereof is set upright substantially in the vertical direction in the normal use state.

To achieve the third object, according to still another aspect of the present invention, a wireless network terminal is provided with the wireless transmission/reception card described above, a headset serving as the wireless transmission/reception card supporting apparatus described above, and an electric appliance. Here, the headset and the electric appliance have communication interfaces compatible with each other.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a perspective exterior view of a wireless transmission/reception card according to the invention;

FIG. 2 is a diagram showing the construction of a headset according to the invention;

FIG. 3A is a diagram showing a wireless access point located on the same horizontal plane as the headset according to the invention;

FIG. 3B is a diagram showing a wireless access point located on a higher level than the headset according to the invention;

FIG. 4 is a diagram showing the construction of a headset according to the invention, in a case where it is provided with a patch antenna;

FIG. 5 is a circuit block diagram of a wireless network terminal according to the invention;

FIG. 6 is a perspective exterior view of a liquid crystal television monitor according to the invention;

FIG. 7 is a diagram showing an example of the construction of a conventional wireless mobile terminal;

FIG. 8 is a diagram showing another example of the construction of a conventional wireless mobile terminal;

FIG. 9A is a perspective exterior view of a wireless LAN card having foldable antennas, in the state with its antennas folded; and

FIG. 9B is a perspective exterior view of a wireless LAN card having foldable antennas, in the state with its antennas unfolded.

### DESCRIPTION OF THE PREFERRED EMBODIMENTS

First, a wireless transmission/reception card according to the invention will be described. According to the invention, a wireless transmission/reception card is provided with at least one pole-shaped antenna for wireless transmission and reception, and the length direction of this pole-shaped antenna is substantially parallel to the main faces of the wireless transmission/reception card. It should be noted here that the main faces of a card denote, of the six faces of a substantially rectangular parallelepiped shape of the card, the two which have the largest area.

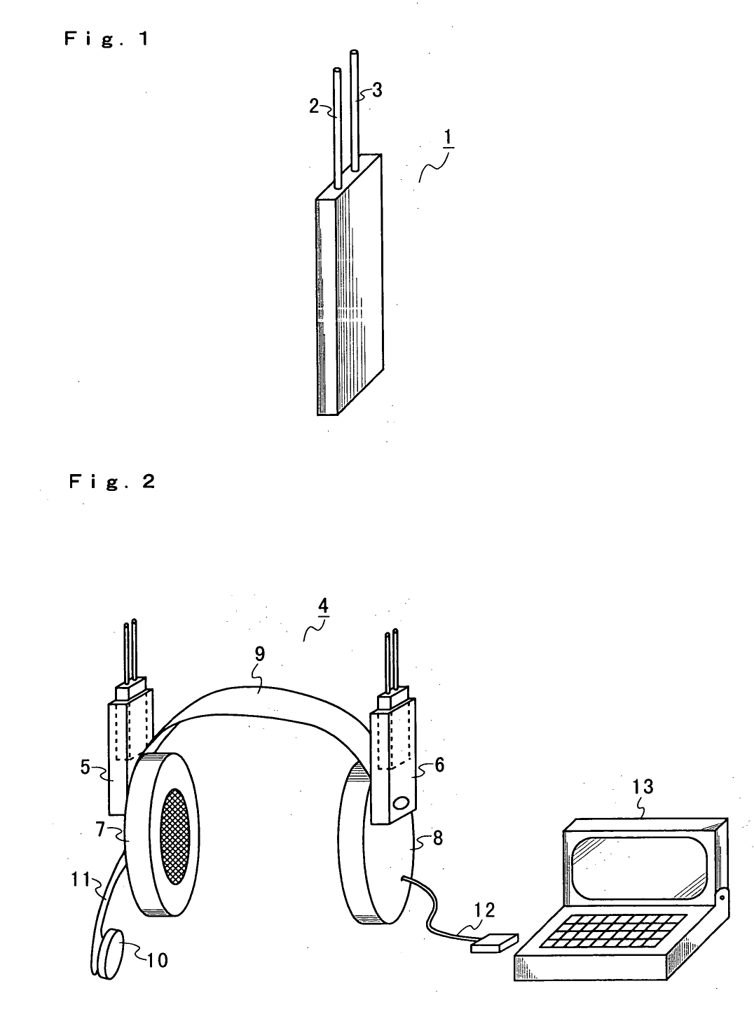

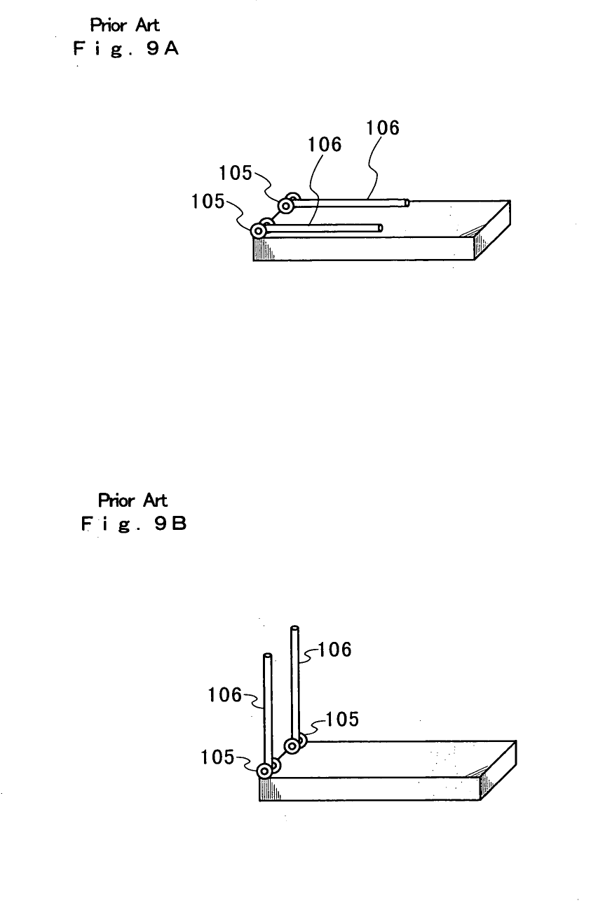

FIG. 1 shows a perspective exterior view of a wireless transmission/reception card according to the invention. The wireless transmission/reception card 1 shown in FIG. 1 is provided with two pole-shaped antennas 2 and 3 for achieving transmission and reception by a diversity method. The length direction of the pole-shaped antennas 2 and 3 is substantially parallel to the main faces of the wireless transmission/reception card. According to the invention, a wireless transmission/reception card is so constructed that a pole-shaped antenna provided therein is substantially parallel to the main faces of the wireless transmission/reception card, and thus the wireless transmission/reception card is flat-plate-shaped as a whole. This makes the wireless transmission/reception card more easily portable, i.e., can more easily be put in a bag or the like that is carried around, than a wireless transmission/reception card that is so constructed that an antenna provided therein protrudes perpendicularly from one of the main faces of the wireless transmission/reception card and that is thus L-shaped as a whole. Moreover, here, there is no need to make the antenna foldable as in the wireless LAN card shown in FIGS. 9A and 9b. This helps save the user the trouble of setting the pole-shaped antenna upright every time the wireless transmission/reception card is used.

Although this embodiment deals with a wireless transmission/reception card provided with two pole-shaped antennas, a wireless transmission/reception card according to the invention may be provided with any other number of pole-shaped antennas. That is, there may be provided, for example, only one pole-shaped antenna or three or more pole-shaped antennas. Although this embodiment deals with a case where the pole-shaped antennas are substantially parallel to the longer sides of the main faces of the wireless transmission/reception card (see FIG. 1), a wireless transmission/reception card according to the invention may be constructed in any other manner. That is, a pole-shaped antenna does not necessarily have to be arranged parallel to the longer sides of the main faces of the wireless transmission/reception card.

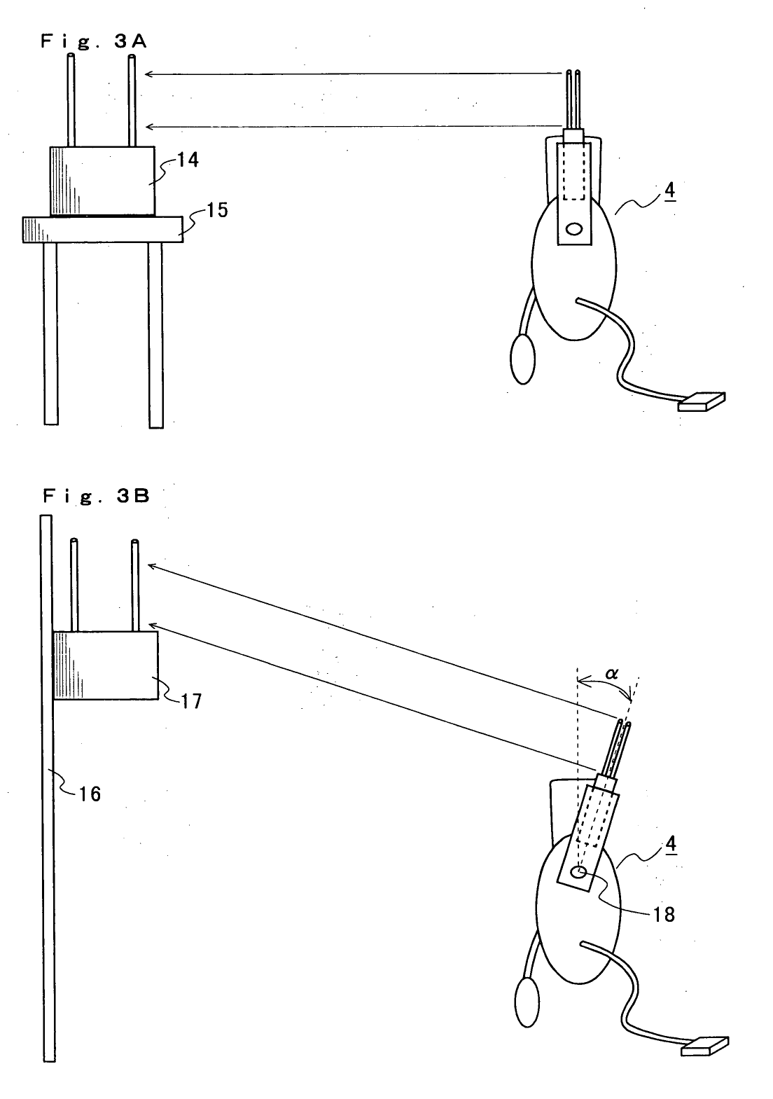

Next, a headset according to the invention will be described. A headset according to the invention permits the wireless transmission/reception card shown in FIG. 1 to be mounted thereon. FIG. 2 shows a perspective exterior view of a headset according to the invention with the wireless transmission/reception card shown in FIG. 1 mounted thereon.

The headset 4 shown in FIG. 2 is provided with slots 5 and 6, earpieces 7 and 8, a bridge 9, a microphone 10, an arm 11, and a USB cable 12. The slot 5 is provided outside the earpiece 7 in such a way that, when the wireless transmission/reception card is inserted in the slot 5, the pole-shaped antennas thereof are kept upright substantially in the vertical direction in the normal use state of the headset 4. The slot 6 is provided outside the earpiece 8 in such a way that, when the wireless transmission/reception card is inserted in the slot 6, the pole-shaped antennas thereof are kept upright substantially in the vertical direction in the normal use state of the headset 4. When two of the wireless transmission/reception card shown in FIG. 1 are inserted respectively in the slots 5 and 6, the USB interfaces (not illustrated) provided inside the wireless transmission/reception cards are connected to the USB interface (not illustrated) provided inside the headset 4. It should be noted here that the normal use state of a headset denotes the state in which the headset is worn correctly by the user (for example, where the headset is so constructed as to include a bridge 9 as shown in FIG. 2, the headset is worn in such a way that the bridge 9 bridges over the user's head) and the top of the user's head is pointing vertically upward (that is, not when the user is lying on his or her back or side).

For example, advisably, a wireless transmission/reception card operating in the 2.4 GHz band is inserted in the slot 5 and a wireless transmission/reception card operating in the 5.2 GHz band is inserted in the slot 6. This makes it possible to wirelessly transmit and receive two kinds of data. For example, wireless transmission/reception in the 2.4 GHz band can be used for IP telephony, and wireless transmission/reception in the 5.2 GHz band can be used for AV streams.

Inside the earpieces 7 and 8 are respectively provided small loudspeakers. The bridge 9 couples together the earpieces 7 and 8 in such a way as to bridge over the user's head in the normal use state. The microphone 10 is coupled to the earpiece 7 by the arm 11 so as to be held at the user's mouth in the normal use state. The USB cable 12 is connected, at one end, to the earpiece 8, and is connected, at the other end, to a USB connector of a notebook personal computer 13. This permits the wireless transmission/reception cards inserted in the slots 5 and 6 to be electrically connected by way of the headset 4 to the notebook personal computer 13, and permits electric power to be supplied from the notebook personal computer 13 to the wireless transmission/reception cards inserted in the slots 5 and 6 and to the headset 4 itself.

With this construction, in the normal use state of the headset 4, the pole-shaped antennas of the wireless transmission/reception cards inserted in the slots 5 and 6 are kept upright substantially in the vertical direction. Moreover, in the normal use state of the headset 4, the pole-shaped antennas never come below the level of the user's face, and thus the pole-shaped antennas, as seen from the transmission/reception partner (for example, a wireless access point, wireless home gateway, or the like), never come behind the user's body. This makes it possible to obtain high antenna gains in all directions through 360 degrees in the horizontal plane in the normal use state.

Moreover, the wireless transmission/reception cards are supported by being inserted in the slots 5 and 6 of the headset 4. This saves the user the trouble of supporting them by hand or by other means, and the trouble of trying to improve the transmission/reception characteristics of the antennas by placing the wireless transmission/reception cards and thus the antennas in an appropriate high position or by preparing an external antenna separately and running an antenna cable from the wireless transmission/reception cards to the external antenna.

A dipole antenna, which is a kind of pole-shaped antenna, can offer an antenna gain of 2.14 dBi through 360 degrees in the horizontal plane. On the other hand, a chip-shaped interior antenna as shown in FIG. 7, typically, is nondirectional and offers an antenna gain of about 0 dBi, seldom offering an antenna gain over 2.14 dBi in current technology. Accordingly, it is possible to obtain a higher antenna gain proper in the case shown in FIG. 2 than in the case shown in FIG. 7.

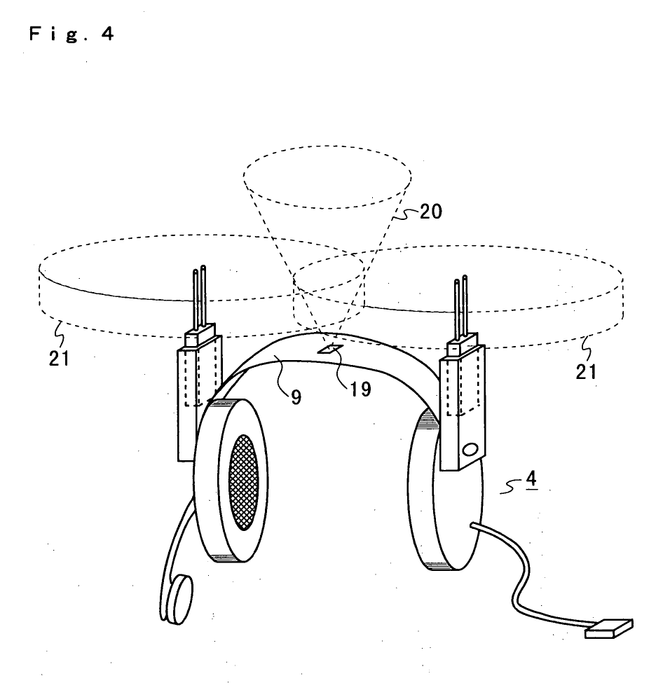

In the headset 4, for better transmission/reception characteristics, it is preferable that the slots 5 and 6 be made rotatable in such a way as not to permit the direction normal to the main faces of the wireless transmission/reception cards inserted therein to change. By permitting the slots 5 and 6 to rotate in such a way, it is possible to keep the pole-shaped antennas of the wireless transmission/reception cards inserted in the slots 5 and 6 inclined at an arbitrary angle forward or rearward relative to the vertical direction in the normal use state of the headset 4. The reason that it is preferable that the slots 5 and 6 be made rotatable will be described below with reference to FIGS. 3A and 3B. In FIGS. 3A and 3B, such components as are found also in FIG. 2 are identified with the same reference numerals, and their detailed explanations will not be repeated.

For example, in a case where, as shown in FIG. 3A, a wireless access point 14 is installed on a desk 15, when the pole-shaped antennas of the wireless transmission/reception cards mounted on the headset 4 are located on the same horizontal plane as the antennas of the wireless access point 14, it is possible for both the wireless transmission/reception cards mounted on the headset 4 and the wireless access point 14 to receive the radio waves from each other with high signal intensity and thus to perform transmission and reception in good condition. Accordingly, so long as the pole-shaped antennas of the wireless transmission/reception cards mounted on the headset 4 are located on the same horizontal plane as the antennas of the wireless access point 14, keeping the length direction of the pole-shaped antennas of the wireless transmission/reception cards mounted on the headset 4 fixed causes no problem whatsoever. It is to be noted here that the antennas incorporated in the wireless access point 14 offer an antenna gain comparable to that of the antennas of the wireless transmission/reception cards mounted on the headset 4. Moreover, it is assumed here that, though not illustrated in FIG. 3A, the headset 4 is supported by being worn on the user's head.

There is, however, also a case where, as shown in FIG. 3B, a wireless access point 17 is hung in a high position on a wall 16 with a view to covering as wide a possible area in a room as an area in which transmission and reception are possible. In this case, keeping the length direction of the pole-shaped antennas of the wireless transmission/reception cards mounted on the headset 4 fixed causes the levels of the horizontal planes on which the pole-shaped antennas of the wireless transmission/reception cards mounted on the headset 4 and the antennas of the wireless access point 17 exhibit a high antenna gain with respect to each other deviate vertically from each other. This diminishes the signal strength with which the antennas on both sides receive the radio waves from each other, and thus narrows the area in which transmission and reception can be performed in good condition.

To overcome this problem, as shown in FIG. 3B, the slots are made rotatable about pivots 18 in such a way as not to permit the direction normal to the main faces of the wireless transmission/reception cards inserted in the slots to change. This permits the pole-shaped antennas of the wireless transmission/reception cards inserted in the slots to be inclined at an arbitrary angle frontward or rearward relative to the vertical direction.

In FIG. 3B, the pole-shaped antennas of the wireless transmission/reception cards are inclined at α degrees rearward relative to the vertical direction. This angle α can be adjusted according to where the wireless access point 17 is located so that the pole-shaped antennas of the wireless transmission/reception cards exhibit a directivity that points to the antennas of the wireless access point 17. This helps increase the signal intensity with which the pole-shaped antennas of the wireless transmission/reception cards transmit radio waves to the wireless access point 17 and with which the pole-shaped antennas of the wireless transmission/reception cards receive radio waves from the wireless access point 17. In this way, it is possible to obtain better transmission/reception characteristics, and as a result to perform transmission and reception in good condition in a wider area. It is to be noted here that the antennas incorporated in the wireless access point 17 offer an antenna gain comparable to that of the antennas of the wireless transmission/reception cards mounted on the headset 4. Moreover, it is assumed here that, though not illustrated in FIG. 3B, the headset 4 is supported by being worn on the user's head.

As described above, in this embodiment, the slots are made rotatable in such a way as not to permit the direction normal to the main faces of the wireless transmission/reception cards inserted therein to change. It is, however, also possible to implement the present invention in any other manner. That is, the slots may be made rotatable in such a way as to permit the direction normal to the main faces of the wireless transmission/reception cards inserted therein to change. In a case where the slots are made rotatable in such a way as to permit the direction normal to the main faces of the wireless transmission/reception cards inserted therein to change, the pole-shaped antennas of the wireless transmission/reception cards inserted in the slots can be inclined at an arbitrary angle, for example, leftward or rightward relative to the vertical direction.

With a view to increasing the antenna gain in the vertical direction, a patch antenna 19 may be additionally provided inside or on the surface of the bridge 9 of the headset 4 as shown in FIG. 4 so that transmission and reception are performed by a diversity method by the use of the patch antenna 19 and the pole-shaped antennas of the wireless transmission/reception cards. The patch antenna 19 exhibits a conical directivity 20, and this improves the transmission/reception characteristics in the vertically upward directions, for example, in the upstairs direction in a house or building. This makes it possible to cope with a case where the pole-shaped antennas of the wireless transmission/reception cards alone do not offer a satisfactorily high antenna gain in the vertically upward direction in the normal use state of the headset 4 and it is difficult to obtain a satisfactorily high gain in the vertically upward direction even when the slots are rotated as shown in FIG. 3B.

In this embodiment, only one patch antenna is provided in the headset 4. Needless to say, it is also possible to provide and arrange a plurality of such patch antennas so as to cover as wide a range of directions as possible where the pole-shaped antennas do not cover with their respective directivity 21 and thereby minimize the null points in the antenna gain. For example, it is possible to shape the bridge 9 in such a way that it protrudes rearward from the user's head and provide a small patch antenna in the protruding portion thereof in such a way as to point downward so as to exhibit a conical directivity downward. This helps improve the transmission/reception characteristics in the downstairs direction in a house or building.

In this embodiment, there are provided two slots in the headset. It is, however, also possible to implement the present invention in any other manner. For example, there may be provided only one slot. Although this embodiment deals with a case where the headset is provided with a microphone, there is no need to provide a microphone in a case where the voice of the user does not need to be transmitted. The slots may be incorporated in the earpieces.

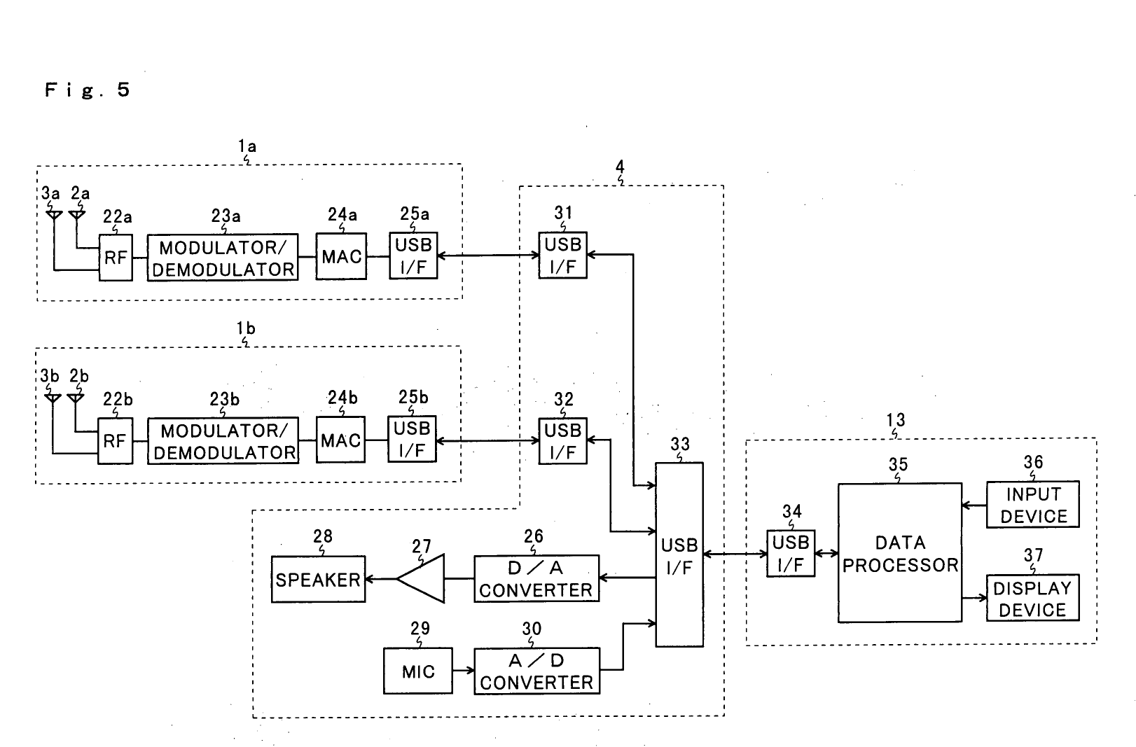

FIG. 5 shows a circuit diagram of a wireless network terminal built with the headset 4 shown in FIG. 2 combined with wireless transmission/reception cards that are mounted on the headset 4 and a notebook personal computer 13 that is provided with a USB connector.

The wireless transmission/reception card 1a includes pole-shaped antennas 2a and 3a, an RF section 22a, a modulator/demodulator section 23a, a media access control section (hereinafter referred to as the MAC section) 24a, and a USB interface 25a. The RF section 22a chooses one of the pole-shaped antennas 2a and 3a according to the level of the received inputted signal, and transmits and receives carriers at a transmission/reception frequency. The modulator/demodulator section 23a performs modulation and demodulation on the transmitted and received video, audio, and other data by methods conforming to various standards. The MAC section 24a performs addition and separation of various kinds control information that are needed for wireless transmission and reception, and performs conversion into and conversion back from a signal format (for example, a format for IP packets, stream data, or the like) used to exchange data with an external appliance (in this embodiment, the notebook personal computer 13). The USB interface 25a performs data communication with the USB interface 31 of the headset 4.

The wireless transmission/reception card 1b has the same circuit block configuration as the wireless transmission/reception card 1a, and therefore no description thereof will be given anew.

The headset 4 includes: a D/A converter 26 that converts a digital signal into an analog signal; an amplifier 27 that amplifies the analog signal outputted from the D/A converter 26; a loudspeaker 28 that outputs sounds according to the output signal of the amplifier 27; a microphone 29; an A/D converter 30 that converts the analog signal outputted from the microphone 29 into a digital signal; and USB interfaces 31 to 33. The notebook personal computer 13 includes: a USB interface 34; a data processor section 35 that decodes and encodes image and sound data and processes control information; an input device (for example, a keyboard) 36 that generates character information and control information to be fed to the data processor section 35; and a display device (for example, a liquid crystal display) 37 that displays images according to the image data outputted from the data processor section 35.

When the wireless transmission/reception card 1a or 1b outputs data, the data is fed, via the USB interface 31 or 32, then via the USB interface 33, and then via the USB interface 34, to the data processor section 35. The data processor section 35 decodes the data fed thereto, and then feeds, if the data is image data, the decoded image data to the display device 37 and, if the data is sound data, the decoded sound data via the USB interfaces 34 and 33 to the D/A converter 26.

When sounds are fed in via the microphone 29, the digital signal outputted from the A/D converter 30 is fed via the USB interfaces 33 and 34 to the data processor section 35. The data processor section 35 encodes the sound data fed thereto, and the encoded sound data is fed, via the USB interface 34, then via the USB interface 33, and then via the USB interface 31 or 32, to the a USB interface 25a of the wireless transmission/reception card 1a or to the USB interface 25b of the wireless transmission/reception card 1b.

The headset 4 and the notebook personal computer 13 may be provided with any other type of communication interfaces than USB interfaces. It is preferable, however, that these communication interfaces be of a universally used one. The headset 4 may be connected to any other type of electric appliance than a notebook personal computer 13 so long as the electric appliance is provided with a communication interface compatible with the one with which the headset 4 is provided.

As described above, a headset on which a wireless transmission/reception card is mounted and an electric appliance to which the headset is connected are provided with communication interfaces compatible with each other. This makes it possible to carry only a headset having a wireless transmission/reception card mounted thereon when the user moves to a remote place where an electric appliance provided with a compatible communication interface is already installed. This eliminates the need to carry or transport the electric appliance itself that the user possesses in his or her original place. If the electric appliance installed in the remote place is one ready for high image quality and provided with a large screen, the user can receive videos and images with considerably high quality also in the remote place. Even if the electric appliance installed in the remote place is not one ready for high image quality, so long as it is provided with a compatible communication interface, the user has only to carry the headset having the wireless transmission/reception card mounted thereon when moving to the remote place in order to be able to receive desired videos and images.

Here, even without carrying a headset itself, the user can perform wireless transmission and resection in good condition in a remote place by using a wireless transmission/reception card according to the invention. To achieve that, the only requirement is that, in the remote place, there be installed an electric appliance provided with a slot that permits the pole-shaped antennas of the wireless transmission/reception card to be kept upright in the vertical direction in the normal use state.

In this embodiment, the notebook personal computer is provided with one USB interface, and correspondingly the headset 4 is provided with one USB interface, which is connected to the USB interface of the notebook personal computer. It is, however, also possible to implement the present invention in any other manner. For example, the notebook personal computer may be provided with a plurality of USB interfaces (one for connection to each wireless transmission/reception card and one for connection to the headset). In this case, the USB interface of a wireless transmission/reception card is connected directly to a USB interface provided in the personal computer for connection to a wireless transmission/reception card, the headset is provided with a USB interface that is connected only to the D/A and A/D converters, and this USB interface of the headset is connected directly to the interface provided in the personal computer for connection to the headset.

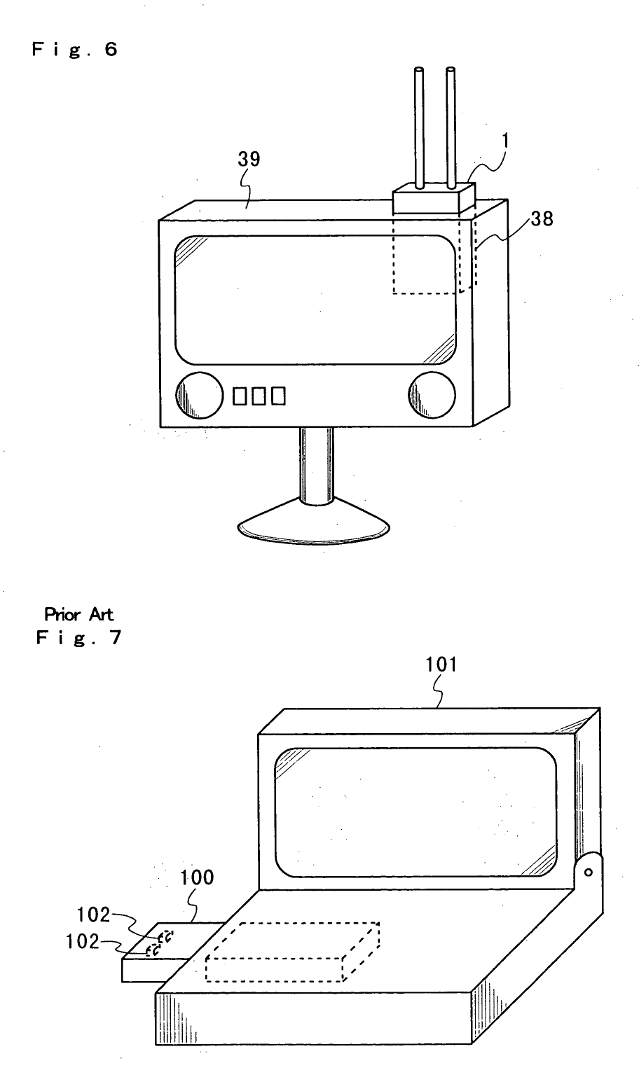

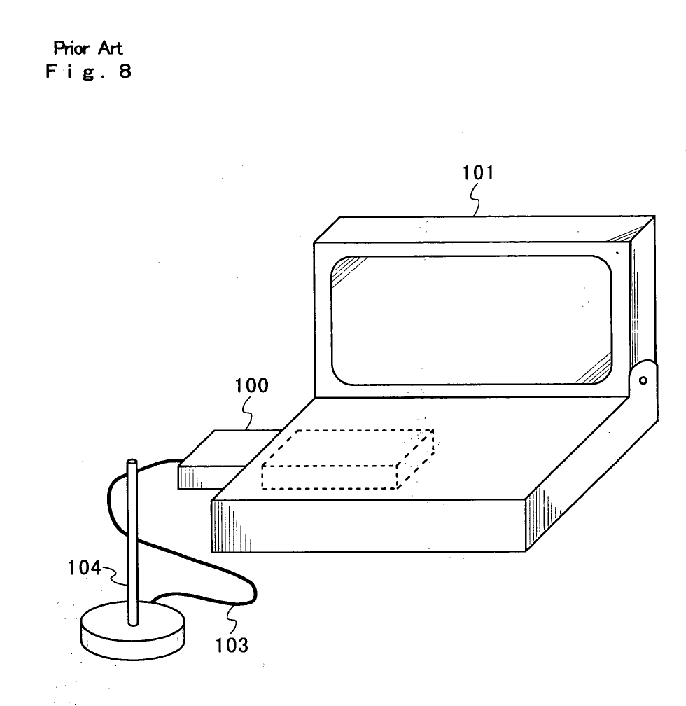

Next, a description will be given of a liquid crystal television monitor as an example of an electric appliance that needs to be installed in a remote place in order that the user, moving to the remote place without carrying a headset itself, can perform wireless transmission and reception in good condition in the remote place by using a wireless transmission/reception card according to the invention. FIG. 6 shows a perspective exterior view of a liquid crystal television monitor according to the invention. In FIG. 6, such components as are found also in FIG. 1 are identified with the same reference numerals, and their detailed explanations will not be repeated. The liquid crystal television monitor shown in FIG. 6 is provided with a slot 38. When a wireless transmission/reception card 1 is inserted in the slot 38, the pole-shaped antennas of the wireless transmission/reception card 1 are kept upright substantially in the vertical direction, and the USB interface (not illustrated) provided inside the wireless transmission/reception card 1 is connected to the USB interface (not illustrated) provided inside the liquid crystal television monitor, making data exchange possible between the liquid crystal television monitor shown in FIG. 6 and the wireless transmission/reception card 1. In the liquid crystal television monitor shown in FIG. 6, as a result of the wireless transmission/reception card 1 being inserted in the slot 38, the pole-shaped antennas of the wireless transmission/reception card 1 are kept upright substantially in the vertical direction. This helps enhance the antenna gain in the horizontal plane in the normal use state. However, depending on where the liquid crystal television monitor is installed, the pole-shaped antennas of the wireless transmission/reception card mounted on the liquid crystal television monitor may be located, as seen from a transmission/reception partner (for example, a wireless access point, wireless home gateway, or the like), behind the user's body. This lowers the antenna gain.

In the liquid crystal television monitor shown in FIG. 6, as in the headset described earlier, the slot may be made rotatable so as to permit the direction of the pole-shaped antennas of the wireless transmission/reception card 1 to be adjusted. A patch antenna may be additionally provided inside or on the surface of the top face of the liquid crystal television monitor. There may be provided a plurality of such patch antennas so as to cover as wide a range of directions as possible where the pole-shaped antennas do not cover with their respective directivity and thereby minimize the null points in the antenna gain. The wireless transmission/reception card 1 and the liquid crystal television monitor may incorporate any other type of communication interfaces than USB interfaces. The present invention may be applied to any other type of electric appliance than liquid crystal television monitors; for example, the present invention can be applied to various types of video appliances, information appliances, communication appliances, and other household appliances.

1. A wireless transmission/reception card comprising:
a pole-shaped antenna;
a transmitter/receiver that is connected to the pole-shaped antenna,
wherein a length direction of the pole-shaped antenna is substantially parallel to a main face of the wireless transmission/reception card.

2. A wireless transmission/reception card supporting apparatus comprising:
a mount on which a wireless transmission/reception card is mounted,
said wireless transmission/reception card comprises a pole-shaped antenna and a transmitter/receiver that is connected to the pole-shaped antenna, a length direction of the pole-shaped antenna being substantially parallel to a main face of the wireless transmission/reception card, and
wherein, when the wireless transmission/reception card is mounted on the mount, the pole-shaped antenna of the wireless transmission/reception card is set upright substantially in a vertical direction in a normal use state.

3. The wireless transmission/reception card supporting apparatus according to claim 2,
wherein the wireless transmission/reception card supporting apparatus is a headset.

4. The wireless transmission/reception card supporting apparatus according to claim 3,
wherein the mount is rotatable.

5. The wireless transmission/reception card supporting apparatus according to claim 3,
wherein said headset includes a pair of earpieces, a bridge that couples together the earpieces in such a way as to bridge over a head of a user in the normal use state, and a patch antenna arranged in the bridge.

6. The wireless transmission/reception card supporting apparatus according to claim 2,
wherein the wireless transmission/reception card supporting apparatus is an electric appliance.

7. The wireless transmission/reception card supporting apparatus according to claim 6,
wherein the mount is rotatable.

8. The wireless transmission/reception card supporting apparatus according to claim 6,
further comprising a patch antenna.

9. A wireless network terminal comprising:
a wireless transmission/reception card;
a headset; and
an electric appliance,
said wireless transmission/reception card comprises a pole-shaped antenna and a transmitter/receiver that is connected to the pole-shaped antenna, a length direction of the pole-shaped antenna being substantially parallel to a main face of the wireless transmission/reception card, and
said headset includes a mount on which the wireless transmission/reception card is mounted, the pole-shaped antenna of the wireless transmission/reception card being set upright substantially in a vertical direction in a normal use state when the wireless transmission/reception card is mounted on the mount,
wherein the headset and the electric appliance have communication interfaces compatible with each other.

10. The wireless network terminal according to claim 9,
wherein the mount is rotatable.

11. The wireless network terminal according to claim 9,
wherein the headset includes a pair of earpieces, a bridge that couples together the earpieces in such a way as to bridge over a head of a user in the normal use state, and a patch antenna arranged in the bridge.
